(19) United States
(12) Patent Application Publication
(10) Pub. No.: US 2017/0112593 A1
(43) Pub. Date: Apr. 27, 2017

(54) Teeth Protection Assembly

(71) Applicant: Jodi Feeney, Manalapan, NJ (US)

(72) Inventor: Jodi Feeney, Manalapan, NJ (US)

(21) Appl. No.: 14/919,419

(22) Filed: Oct. 21, 2015

(51) Int. Cl. A61C 5/14

(52) U.S. Cl. CPC A61C 5/14

(57) ABSTRACT

A teeth protection assembly includes a first guard that may be positioned on an upper row of teeth. The first guard is comprised of a fluid impermeable material. Thus, the first guard prevents the upper row of teeth from being stained while a beverage is consumed. A second guard is provided and the second guard may be positioned on a lower row of teeth. The second guard is comprised of a fluid impermeable material. Thus, the second guard prevents the lower row of teeth from is stained while the beverage is consumed.

### BACKGROUND OF THE DISCLOSURE

### Field of the Disclosure

The disclosure relates to protection devices and more particularly pertains to a new protection device for preventing teeth from being stained by a beverage.

### SUMMARY OF THE DISCLOSURE

An embodiment of the disclosure meets the needs presented above by generally comprising a first guard that may be positioned on an upper row of teeth. The first guard is comprised of a fluid impermeable material. Thus, the first guard prevents the upper row of teeth from being stained while a beverage is consumed. A second guard is provided and the second guard may be positioned on a lower row of teeth. The second guard is comprised of a fluid impermeable material. Thus, the second guard prevents the lower row of teeth from is stained while the beverage is consumed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a teeth protection assembly according to an embodiment of the disclosure.

FIG. 2 is a top view of an embodiment of the disclosure.

FIG. 3 is a bottom view of an embodiment of the disclosure.

FIG. 4 is a front view of an embodiment of the disclosure.

FIG. 5 is a perspective in-use view of an embodiment of the disclosure.

### DESCRIPTION OF THE PREFERRED EMBODIMENT

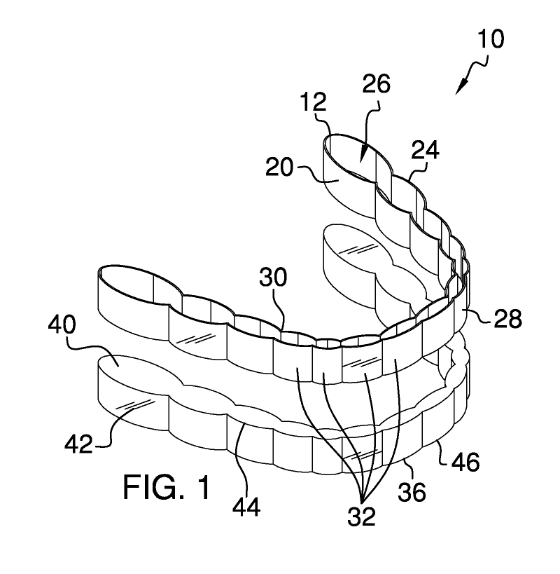

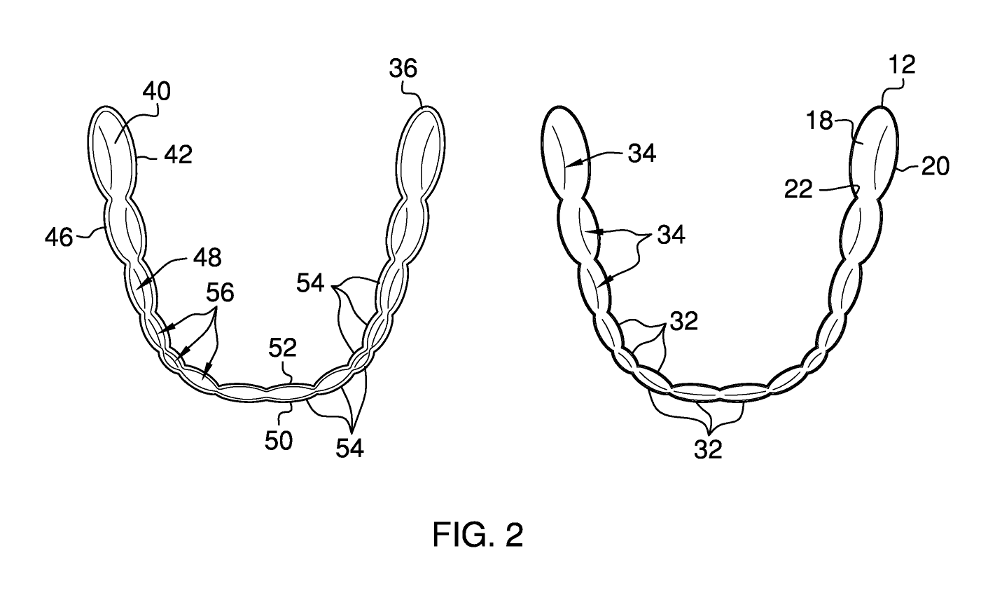

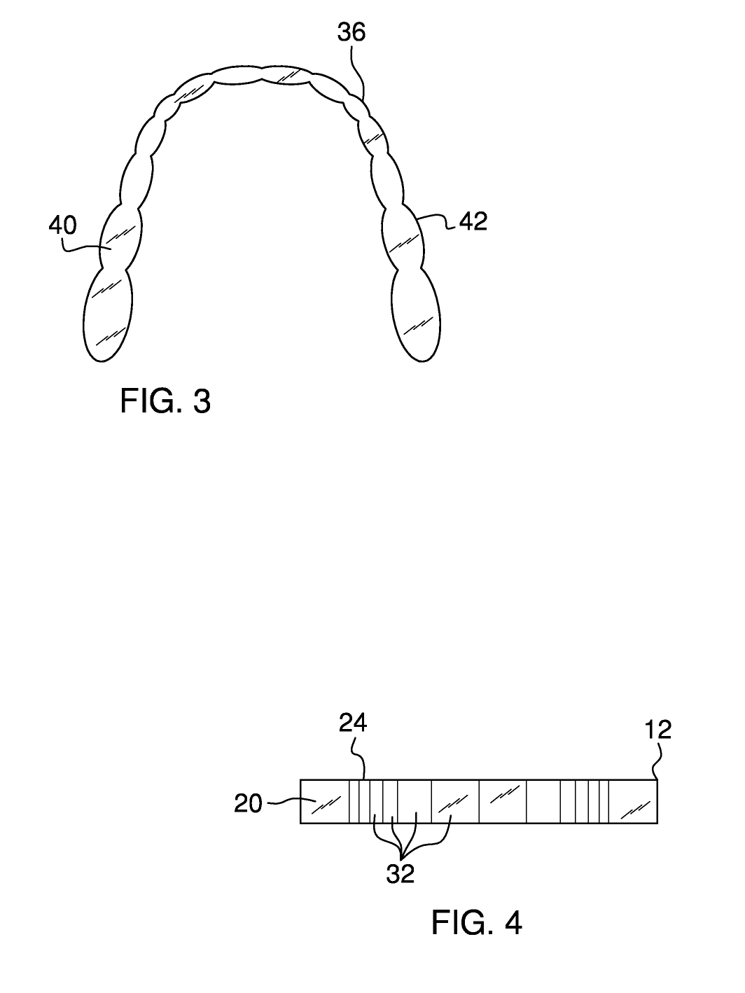

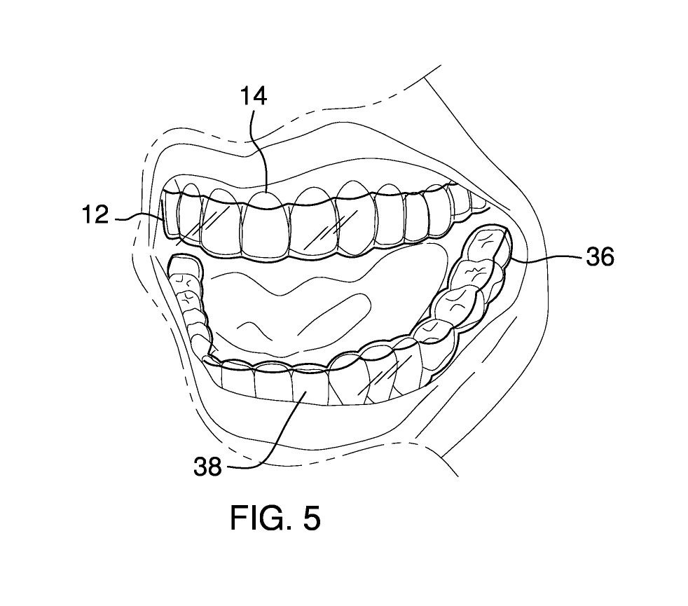

With reference now to the drawings, and in particular to FIGS. 1 through 5 thereof, a new protection device embodying the principles and concepts of an embodiment of the disclosure and generally designated by the reference numeral 10 will be described.

As best illustrated in FIGS. 1 through 5, the teeth protection assembly 10 generally comprises a first guard 12 that may be positioned on an upper row of teeth 14. The first guard 12 is comprised of a fluid impermeable material. Thus, the first guard 12 prevents the upper row of teeth 14 from being stained while a beverage is consumed. The beverage may be a highly acidic beverage having chromogens and tannins such as red wine, tea or coffee.

The first guard 12 has a bottom wall 18 and a peripheral wall 20 extending upwardly from the bottom wall 18. The bottom wall 18 has an outer edge 22 and the peripheral wall 20 is coextensive with the outer edge 22. The peripheral wall 20 has a distal edge 24 with respect to the bottom wall 18 to define an opening 26 into the first guard 12. The opening 26 receives each of the upper row of teeth 14. The bottom wall 18 is curved such that the first guard 12 has a U-shape. Thus, the first guard 12 is coextensive with the upper row of teeth 14 when the first guard 12 is worn on the upper row of teeth 14.

The peripheral wall 20 has a front side 28 and a back side 30. Each of the front side 28 and the back side 30 has a plurality of prominences 32. The prominences 32 on each of the front side 28 and the back side 30 are distributed along the first guard 12. The prominences 32 on the front side 28 are aligned with an associated one of the prominences 32 on the back side 30 to define a plurality of tooth pockets 34. Each of the tooth pockets 34 surrounds one of the upper row of teeth 14 when the first guard 12 is worn on the upper row of teeth 14.

A second guard 36 is provided and the second guard 36 may be positioned on a lower row of teeth 38. The second guard 36 is comprised of a fluid impermeable material. Thus, the second guard 36 may prevent the lower row of teeth 38 from being stained while the beverage 16 is consumed. The second guard 36 has a top wall 40 and an exterior wall 42 extending downwardly from the top wall 40. The top wall 40 has an outer edge 44 and the exterior wall 42 is coextensive with the outer edge 44 of the top wall 40.

The exterior wall 42 has a distal edge 46 with respect to the top wall 40 to define an opening 48 into the second guard 36. The opening 48 receives each of the lower row of teeth 38. The top wall 40 is curved such that the second guard 36 has a U-shape. The second guard 36 may be coextensive with the lower row of teeth 38 when the second guard 36 is worn on the lower row of teeth 38.

The exterior wall 42 has a forward side 50 and a rear side 52. Each of the forward side 50 and the rear side 52 has a plurality of prominences 54. The prominences 54 on each of the forward side 50 and the rear side 52 are distributed along the second guard 36. The prominences 54 on the forward side 50 are aligned with an associated one of the prominences 54 on the rear side 52 to define a plurality of tooth pockets 56. Each of the tooth pockets 56 surrounds one of the lower row of teeth 38 when the second guard 36 is worn on the lower row of teeth 38.

In use, the first guard 12 is worn on the upper row of teeth 14 and the second guard 36 is worn on the lower row of teeth 38. The beverage 16 is consumed and the upper row of teeth 14 and the lower row of teeth 38 are protected from the beverage 16. The first guard 12 and the second guard 36 are removed after the beverage 16 has been consumed. Each of the first guard 12 and the second guard 36 are discarded after the beverage 16 has been consumed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A teeth protection assembly comprising:
a first guard being configured to be positioned on an upper row of teeth, said first guard being comprised of a fluid impermeable material wherein said first guard is configured to prevent the upper row of teeth from being stained while a beverage is consumed; and
a second guard being configured to be positioned on a lower row of teeth, said second guard being comprised of a fluid impermeable material wherein said second guard is configured to prevent the lower row of teeth from being stained while the beverage is consumed.

2. The assembly according to claim 1, wherein said first guard has a bottom wall and a peripheral wall extending upwardly from said bottom wall, said bottom wall having an outer edge, said peripheral wall being coextensive with said outer edge, said peripheral wall having a distal edge with respect to said bottom wall to define an opening into said first guard wherein said opening is configured to receive each of the upper row of teeth.

3. The assembly according to claim 2, wherein said bottom wall is curved such that said first guard has a U-shape wherein said first guard is configured to be coextensive with the upper row of teeth when said first guard is worn on the upper row of teeth, said peripheral wall having a front side and a back side, each of said front side and said back side having a plurality of prominences.

4. The assembly according to claim 3, wherein said prominences on each of said front side and said back side are distributed along said first guard, said prominences on said front side being aligned with an associated one of said prominences on said back side to define a plurality of tooth pockets wherein each of said tooth pockets is configured to surround one of the upper row of teeth.

5. The assembly according to claim 1, wherein said second guard has a top wall and an exterior wall extending downwardly from said top wall, said top wall having an outer edge, said exterior wall being coextensive with said outer edge of said top wall, said exterior wall having a distal edge with respect to said top wall to define an opening into said second guard wherein said opening is configured to receive each of the lower row of teeth.

6. The assembly according to claim 5, wherein said top wall is curved such that said second guard has a U-shape wherein said second guard is configured to be coextensive with the lower row of teeth when said second guard is worn on the lower row of teeth, said exterior wall having a forward side and a rear side, each of said forward side and said rear side having a plurality of prominences.

7. The assembly according to claim 6, wherein said prominences on each of said forward side and said rear side are distributed along said second guard, said prominences on said forward side being aligned with an associated one of said prominences on said rear side to define a plurality of tooth pockets wherein each of said tooth pockets is configured to surround one of the lower row of teeth.

8. A teeth protection assembly comprising:
a first guard being configured to be positioned on an upper row of teeth, said first guard being comprised of a fluid impermeable material wherein said first guard is configured to prevent the upper row of teeth from being stained while a beverage is consumed, said first guard having a bottom wall and a peripheral wall extending upwardly from said bottom wall, said bottom wall having an outer edge, said peripheral wall being coextensive with said outer edge, said peripheral wall having a distal edge with respect to said bottom wall to define an opening into said first guard wherein said opening is configured to receive each of the upper row of teeth, said bottom wall being curved such that said first guard has a U-shape wherein said first guard is configured to be coextensive with the upper row of teeth when said first guard is worn on the upper row of teeth, said peripheral wall having a front side and a back side, each of said front side and said back side having a plurality of prominences, said prominences on each of said front side and said back side being distributed along said first guard, said prominences on said front side being aligned with an associated one of said prominences on said back side to define a plurality of tooth pockets wherein each of said tooth pockets is configured to surround one of the upper row of teeth; and
a second guard being configured to be positioned on a lower row of teeth, said second guard being comprised of a fluid impermeable material wherein said second guard is configured to prevent the lower row of teeth from being stained while the beverage is consumed, said second guard having a top wall and an exterior wall extending downwardly from said top wall, said top wall having an outer edge, said exterior wall being coextensive with said outer edge of said top wall, said exterior wall having a distal edge with respect to said top wall to define an opening into said second guard wherein said opening is configured to receive each of the lower row of teeth, said top wall being curved such that said second guard has a U-shape wherein said second guard is configured to be coextensive with the lower row of teeth when said second guard is worn on the lower row of teeth, said exterior wall having a forward side and a rear side, each of said forward side and said rear side having a plurality of prominences, said prominences on each of said forward side and said rear side being distributed along said second guard, said prominences on said forward side being aligned with an associated one of said prominences on said rear side to define a plurality of tooth pockets wherein each of said tooth pockets is configured to surround one of the lower row of teeth.
